(19) United States
(12) Patent Application Publication
(10) Pub. No.: US 2001/0049657 A1
(43) Pub. Date: Dec. 6, 2001

(54) Method, apparatus and system of merchandise hierarchical online ordering, billing and distribution

(76) Inventor: Erh-Chiao C. Wang, San Jose, CA (US)

Correspondence Address: ERH-CHIAO C. WANG, 1767 Parkview Green Circle, San Jose, CA, 95131, US

(21) Appl. No.: 09/753,740

(22) Filed: Jan. 3, 2001

Related U.S. Application Data
(60) Provisional application No. 60/175,511, filed on Jan. 11, 2000.

(51) Int. Cl. G06F 17/60

(52) U.S. Cl. 705/40; 705/26; 705/37

(57) ABSTRACT

A system, apparatus and method for providing a set of hierarchical online ordering, billing and distribution machines and processes that manage the consumer order, consumer billing, retailer order, retailer billing and merchandise shipment over a distributed computer system is herein disclosed. This invention redefines the role of distributor in the traditional value chain in the Internet Age and reveals the method, apparatus and system of the E-distributor business model and processes. The distributed computer system includes at least one E-distributor server computer that executes the online order from retailers, a group of retailer server computers that execute the customer orders and a group of customers connected to client computers. At least one of the E-distributor servers also provides retailers with product information, pricing rules and billing rules. At least one of each retailer's server computers also provides customers selected product information, retail price, promotion information, etc. The end customer orders products through an E-retailer. The said E-retailer bills the customer the said E-retailer defined retail price and shipping and handling charge via any acceptable means of payment that said E-retailer accepted, and submits the order to E-distributor. E-distributor charges the E-retailer's E-deposit account the E-distributor defined wholesale price and fulfillment charge according to the end customer selected shipping method. E-distributor fulfills the customer order by the shipping methods that end customer specified.

### CROSS-REFERENCE TO RELATED APPLICATIONS

U.S. Provisional Patent Application 60/175,511 Jan. 11, 2000 Erh-Chiao C. Wang

### STATEMENT REGARDING FEDERALLY SPONSORED RESEARCH OR DEVELOPMENT

Not applicable

### BACKGROUND OF THE INVENTION

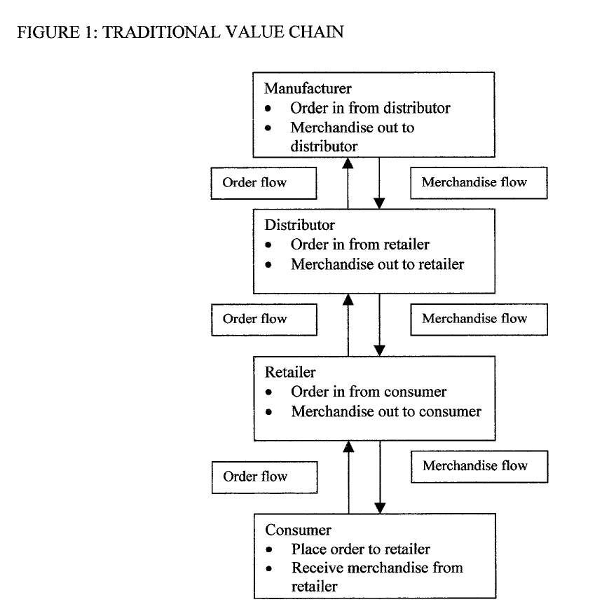

The present invention is to address the problem of lacking profitability of the online retailing businesses while maintaining the same level of or better value to the end customers. The current practice, becoming big online retailer or eliminating distributor within the value chain, will not achieve the desire profitability for online retailers. The traditional value chain (FIG. 1) needs to be updated slightly by rearranging the activities that each role conducts, not eliminating any role in the value chain.

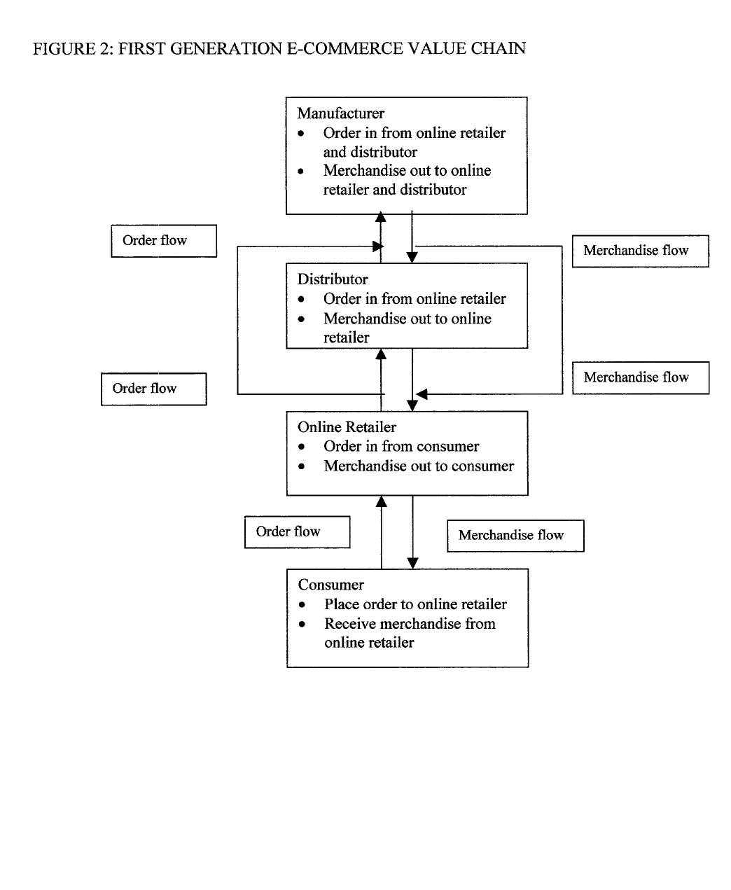

The traditional value chain consists of manufacturer/producer, whole-seller/distributor, retailer and consumer. For certain goods, it may even involve multiple layers of whole-sellers/distributors. The recent online retailers recognize that the Internet enables them to face regional, national and even international customers directly. By partnering with delivering services, the online retailers can order directly from both manufacturers and distributors in reasonable volume and enjoy higher profit margin and also provide customers goods with lower price. As a result, the focus of online retailers has been in the effort of eliminating distributors in the traditional value chain (FIG. 2). The scheme and business model indeed sounds on the surface, if the online retailers can manage not to incur too many new expenses.

The problem has been that, as of today, not many online retailers are actually making money from their online retailing businesses. The problem is caused by the following three factors:

High marketing cost: It is easy for online retailer to reach customers without geographical limitation. It is also equally easy for customers to reach many online retailers on the Internet. Online retailers need to spend on promotion constantly in order to maintain the strength of brand images to customers.

High overhead cost: In order to eliminate the traditional distributors, online retailers need to set up huge infrastructure that was done by traditional distributors and shares by retailers. The so-called extra margin by eliminating distributors is used to and may not be enough to set up warehouse, inventory, fulfillment center, etc. services that were traditionally provided by distributors.

High competition: Online retailing has been highly competitive. The approach has been, especially for general consumer products, that online retailers bought their way in by spending huge amount of money to build up brand names, conduct marketing activities, secure customers via various means of cut throat promotion. The plan is to become the biggest in the product segment. The hope is that whoever can keep losing money without going out of business would be the winners.

All the online retailers are expecting somehow, someday to achieve high volume of goods sold in order to compensate the above three factors. The ways to achieve high volume in goods sold are, unfortunately, to spend more on marketing activities, stock up more merchandises, build more warehouses, enlarge the operation scale, etc. Only a few online retailers have the capital to do both stocking and marketing aggressively at the same time. Since the capital-intensive nature of the online retailer, the barrier of entry to the E-Commerce has become stiffer and stiffer. The whole scenarios are all under the context of the traditional value chain with one general wishful thinking: get rid of distributor to enjoy higher margin as well as the expanded market. And the only hope that distributor can ever be removed is that the online retailer become very big and eventually become a distributor by itself. It is not a healthy economic. What we see today is that there are monopolies in various product segments. Even in the monopoly position, those huge online retailers hardly make any profit.

I firmly believe that, especially in consumer markets, it is beneficial to the publics to have more merchants to participate with fair competitions. However, unfortunately, the current trend of online retailing is to be become as big as possible (for survival and hopefully profitable) and hence create even higher entry barrier to all the entrepreneurs who wish to become online retailers. The invention is intended to help all the creative entrepreneurs to participate in the online retailing business with minimum capital, or minimum entry barrier.

There are a few prior arts that intended to reduce the entry barrier to the want-to-be online retailers toward the benefits of the big online retailers.

### Pseudo Online Retailer—Affiliate Program

From affiliate program members' viewpoint, the additional revenue (commission) generating from online retailer is easy money. In order to increase this part of revenue, the easiest approach is to join as many as affiliate programs as possible. The small businesses are the real force to keep the economic wellbeing. In the Internet Age, do online affiliate programs create value to small businesses? In the first glance, the answer is probably yes. Therefore, the affiliate program was almost an immediate success, a big success to online retailers. However, as for the small businesses, the reward has been limited, if any. The reasons are simple. Firstly, for “click-through” sites that join all types of affiliate programs and hope accidental traffics will lead to potential commission, the prosperity will look good initially but decay as Web surfers realize that there is no added value to go through those “click through sites”. Secondly, for any web sites that invested some money and energy to create the contents, the affiliate program is something nice to have but is not a predictable or controllable source of income. Thirdly, once customers have learned how to get to the real online retailers, they will go there directly when they need to buy something. The “click through” successful rate will become less and less. The affiliate program provides little value to the small businesses. If there is a better way, the serious small Web businesses will turn their affiliate memberships into real online stores.

### Pseudo Affiliate Program—Open Your Own Online Store with Little Cost

From the above analysis, we can see that the real problem that the small Web businesses are facing is still unsolved. The entry barrier to become an online retailer is still very high unless one can manage to find a real small niche market that cash-rich online retailers do not bother to look at. In the later part of 1999, there came a new business model: pseudo affiliate program that enables small Web businesses to open their own online store in a few minutes. (Vstore.COM, AddAShop.COM, the associate program from Amazon.com and the like). The business model is actually an affiliate program with better value provided to small businesses. Small businesses get to sell program provider's products and program provider fulfills the orders. The pseudo affiliate program intends to solve the problem that the present invention intends to solve. However, the approach differs in great deal in essence.

In pseudo affiliate program, small Web businesses open storefronts in pseudo affiliate program provider's server. The stores are not on the small businesses' Web sites. The stores are links in the small businesses' web sites to the pseudo affiliate program provider's server. Once the customer clicks for shopping, the customer will conduct all online shopping activities in pseudo affiliate program provider's server. All the customer information is still on the pseudo affiliate program provider's server. The pseudo affiliate program provider does optionally provide a link in the small businesses' storefronts to go back to small businesses' Web sites. Furthermore, the small Web businesses can not decide the retail price and promotion schemes to differentiate themselves from other stores; hence these members are merely free storefronts for the program providers. From small Web businesses' point of view, it is not a good business. From the pseudo affiliate program provider's point of view, they easily establish many sales channels that cost them little to acquire.

All of these prior arts share at least one of the following attributes: members (small Web businesses) can not recognize revenue immediately. Members can not decide the retail price. Members can not decide how to sell, for example: creating unique sales schemes like additional discount, bundle items, etc. Members do not directly control their customer and sales information. If a small Web business wants to control the above attributes, it immediately faces the capital requirements for inventory, marketing and operations that those big online retailers face.

### DEFINITIONS OF KEY TERMINOLOGIES

The following are a set of terminology definitions that will be used through out the paper:

E-distributor: The redefined distributor in the Internet Age. E-distributor conducts all the typical activities that a typical distributor of the traditional value chain does. In addition, E-distributor also fulfills the E-retailer's customer's order.

E-retailer: The business partner of E-distributor that sells the products in the E-distributor's product catalogs as part or all of its business. E-retailer can be a pure online retailer, hybrid of online retailer and traditional retailer, traditional retailer or any legal business entity that sell merchandise to the public.

E-deposit: an amount of money that E-retailer deposits into the E-retailer's E-deposit account with E-distributor or a line of credit from other financial institute that establishes within the E-retailer's E-deposit account with E-distributor to enable selling certain amount (equal or less than E-deposit) of products from E-distributor's product catalogs.

E-credit: The additional amount of the product value (total in wholesale price) that E-retailer can sell at any given time in additional to that E-deposit allows. E-distributor authorizes certain amount of E-credit to E-retailer based on the credit standing and transaction history of the E-retailer.

E-fee: The fee that E-distributor may choose to charge to certain E-retailers in order to differentiate market segments or any other purpose that E-distributor deems proper and is agreed by the E-retailer.

Online retailer: The current retailer that sells merchandise to public via Internet. E-retailer can be an online retailer. In this paper, the term typically refers to the current venture-backed cash-rich online retailers.

### BRIEF SUMMARY OF THE INVENTION

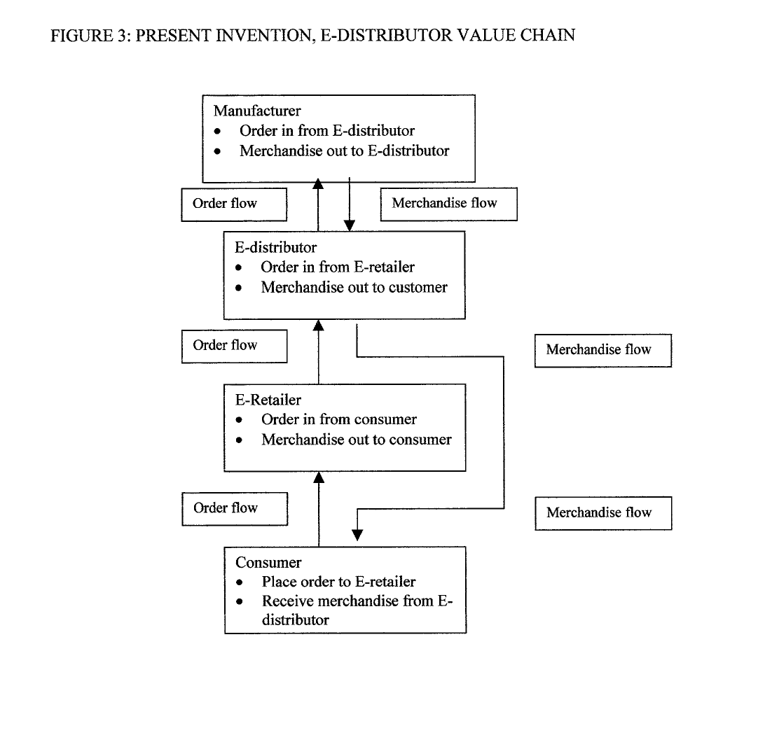

The present invention is directed to a method and apparatus for online retailing activities that include a set of ordering and billing processes. The basic concept of the present invention can be illustrated by FIG. 3: the E-distributor value chain. The end customer orders products through an E-retailer. The said E-retailer charges the customer the predefined retail price (defined by said E-retailer) and shipping and handling charge (defined by said E-retailer) via any acceptable means of payment (normally credit card) that said E-retailer accepts. The order is submitted to the said E-distributor directly. The said E-distributor charges the said E-retailer's E-deposit account the wholesale price (defined by said E-distributor) and fulfillment charge (defined by said E-distributor) according to the said E-retailer's customer selected shipping method. The said E-distributor then fulfills the said E-retailer's customer order by the said E-retailer's customer specified shipping method. The E-deposit account that E-retailer establishes with E-distributor is the major mechanism to govern the relationship between E-distributor and E-retailer.

The present invention enables the E-retailers to reduce or even eliminate the cost of inventory, warehouse and related overhead. It also enables E-retailers to set their own merchandise prices, create their own marketing strategies and establish relationships and bonds with their own customers. In another words, the E-retailers that adopt the invention can still enjoy all the flexibility and controls that the traditional retailers have. Additionally, they can enjoy less or zero inventory and fulfillment burdens. The present invention also reduces the entry barrier to become a retailer and promote the fair competition in the sales of merchandise. Consumer will have more choices to shop from and eventually receive better value from the shopping activities due to healthy retailer competition.

### BRIEF DESCRIPTION OF THE DRAWING

1. FIG. 1: Traditional value chain

2. FIG. 2: First generation E-Commerce value chain

3. FIG. 3: Present invention, E-distributor value chain

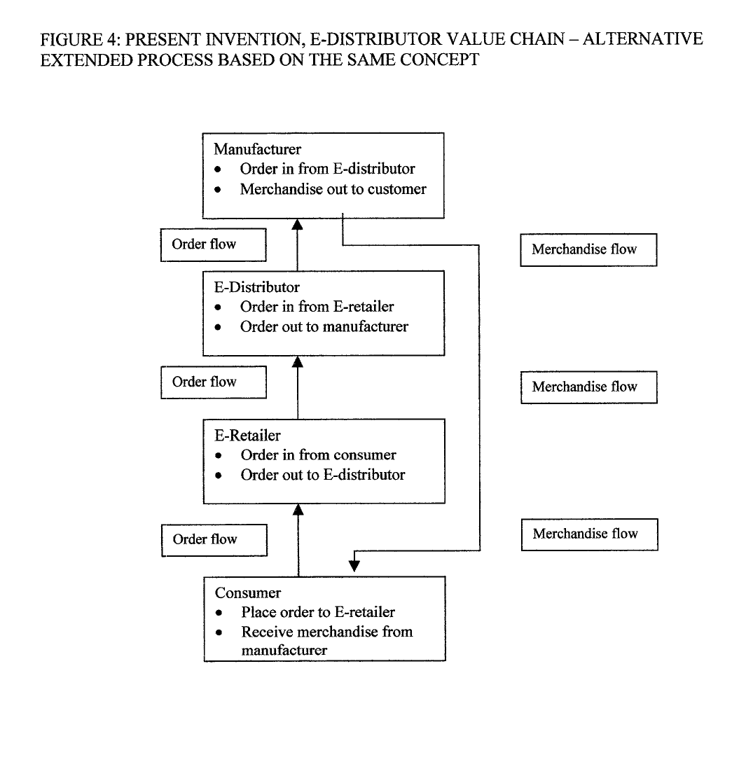

4. FIG. 4: Present invention, E-distributor value chain - Alternative extended process based on the same concept

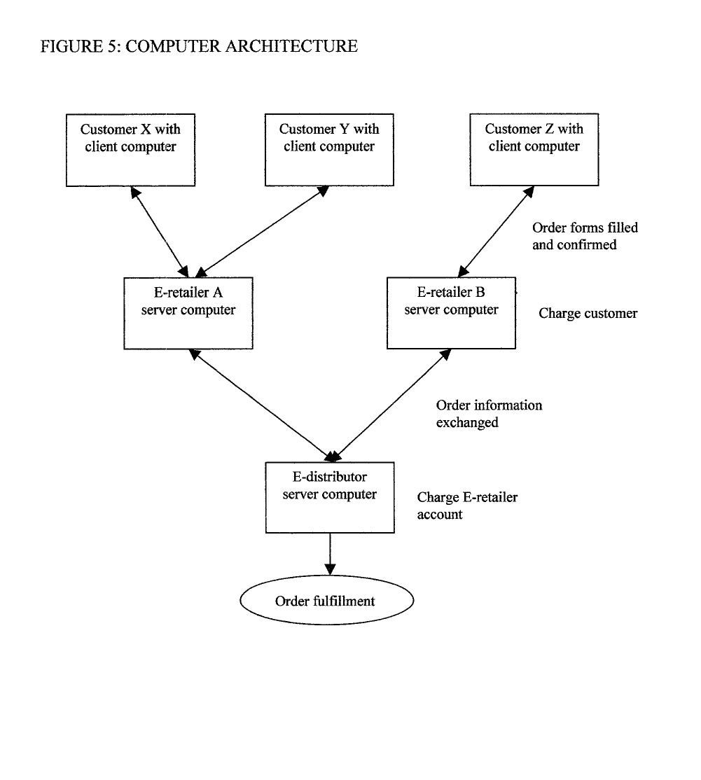

5. FIG. 5: Computer architecture

### DETAILED DESCRIPTION OF THE INVENTION

### Computer Architecture

A distributed computer system is illustrated in FIG. 5. It contains the client computers that are used by customers, E-retailer server computers, E-distributor server computers and related product and order information exchange. The information exchange between any two nodes in the distributed computer system can be achieve by email or any message passing protocol that is allowed to transfer order information securely and accurately on the network. The E-retailer server computers are referring to the server computers that E-retailer has right to use to conduct needed processes. The E-distributor server computers are referring to the server computers that E-distributor has right to use to conduct needed processes. This does not imply that E-retailer or E-distributor must own their server computers, respectively. Likewise, the location of the server computers is not limited as long as they are connected via network.

### Hierarchical Ordering and Billing Processes

The basic concept of the present invention can be illustrated by FIG. 3: the E-distributor value chain. The end customer orders products through an E-retailer's Web pages. The said E-retailer charges the customer the predefined retail price (defined by said E-retailer) and shipping and handling charge (defined by said E-retailer) via any acceptable means of payment (normally credit card) that said E-retailer accepts. The order is submitted to the said E-distributor directly through the said E-retailer's server. The said E-distributor charges the said E-retailer's E-deposit account the wholesale price (defined by said E-distributor) and fulfillment charge (defined by said E-distributor) according to the said E-retailer's customer selected shipping method. The said E-distributor then fulfills the said E-retailer's customer order by the said E-retailer's customer specified shipping method. Upon the completion of the said customer order, both said E-retailer and said E-distributor can recognize the revenue immediately. The E-deposit account that E-retailer establishes with E-distributor is the main mechanism to govern the relationship between E-distributor and E-retailer.

The present invention reveals a new method and system to solve the difficulties that retailers, especially online retailers, are facing: the high entry barrier to become an online retailer. As a viable method and system of itself, the present invention can also benefit the traditional retailers. The following process scenario illustrates the preferred embodiments of the present invention.

1) E-distributor generates product catalog that is updated periodically and as needed, and distributes it to existing and potential E-retailers through printed materials, E-distributor's Web pages or downloadable online materials.

2) In order to become an E-retailer of the E-distributor, the prospect needs to establish an E-deposit account in E-distributor's system.

E-retailer needs to put either money or line of credit in its E-deposit account when establishing relationship with E-distributor. The amount of E-deposit entitles E-retailer to sell equal or less value of merchandises to its customers.

The minimum balance requirement of an E-deposit account is established upon opening the account and can be any amount that is agreed by both E-retailer and E-distributor. The minimum balance requirement will be reviewed and adjusted periodically according to the transaction history of the E-retailer.

The E-retailer's status will change from ACTIVE to SUSPENDED if the E-deposit account minimum balance requirement is not met.

E-retailer should have an initial E-deposit balance higher than minimum balance requirement in order to conduct business and making transactions.

E-retailer will be given E-credit in its E-deposit account by E-distributor after certain criterions being met. E-credit enables E-retailer to sell more than the value of its E-deposit. The E-credit issuing criterions can be any guidelines defined by E-distributor.

E-distributor may choose to charge a reasonable E-fee to some or all E-retailers based on certain criterions. The E-fee charging criterions can be any guidelines defined by E-distributor.

E-deposit account balance of the E-retailer will be charged by the E-distributor for the sum of the product wholesale price, any E-fee associating with the transaction and fulfillment charges upon E-retailer's customer complete the order process. If the sum of the E-deposit account balance and available E-credit can not cover the total transaction amount that should be charged by E-distributor, E-distributor will suspend the transaction and change the E-retailer's status from ACTIVE to SUSPENDED. The SUSPENDED status will remain until E-retailer refill the E-deposit account balance above minimum balance requirement or withdraw the transaction that caused the suspension.

E-retailer is responsible to maintain the minimum balance in its E-deposit account. E-retailer is responsible to refill the E-deposit account and maintain a reasonable E-deposit balance level that is higher than the pre-defined minimum balance according to its normal transaction volume to prevent transaction suspension due to insufficient fund in the E-deposit account.

3) E-retailer decides what to sell and how to sell by referencing E-distributor's product catalog.

E-retailer can sell part or all of the products in E-distributor's catalog.

E-retailer can create bundle merchandise package.

E-retailer can create on sale item.

E-retailer can create other creative marketing schemes to increase sales.

4) E-retailer can decide the retail price of each merchandise the E-retailer chooses to sell

E-retailer can set a fixed price for merchandise individually.

E-retailer can set a fixed monetary margin formula on any item according to E-distributor's wholesale price and suggested retailer price.

E-retailer can set a fixed percentage margin formula on any item according to E-distributor's wholesale price and suggested retailer price.

E-retailer can set a custom monetary margin formula on any item according to E-distributor's wholesale price and suggested retailer price.

E-retailer can set a custom percentage margin formula on any item according to E-distributor's wholesale price and suggested retailer price.

Please notice that it is E-retailer's responsibility to define retail price on any item. Otherwise, E-distributor's current suggested retail price can be the default retail price to show on E-retailer's Web site for retail price.

5) E-retailer promotes the product via E-retailer's Web site, catalog and/or any legal marketing methods.

6) E-retailers can choose to sell E-distributor's merchandises only or sell E-distributor's merchandises along with its own or other vendors' product offerings.

7) Consumer selects to buy product on E-retailer's Web site and go through normal online shopping process. Customers shop through E-retailer the same way as they do with current online retailers.

8) E-retailer may configure the process to check the product availability in any stage between consumer inquire an item and confirm the order. The E-retailer may also implement its other exception handling procedures for unexpected cases like product unavailable, transaction suspended by E-distributor, etc. The following is just a sample process to show the concept:

The default assumption is that the E-distributor always has the item available until receiving the message from E-distributor stating otherwise.

The latest suggested retailer price of this item, if the E-retailer did not configure a pricing rule for this item.

Does E-retailer carry this item in its own warehouse?

E-retailer can configure the program to use its own inventory first

Does E-distributor currently has this item available?

If not, an estimated shipment date can be generated for E-retailer's further process.

Additionally, E-distributor or E-retailer may offer any not-currently-available product a further discount in order to keep the customer.

9) E-distributor may allow E-retailer, based on different product nature and contractual concerns, to configure the program at certain stage of the consumer shopping process to show product stocking and estimated availability before Consumer confirm the order.

10) When Consumer confirms the order, if the order would go through E-distributor (meaning E-retailer choose to use E-distributor's services), E-retailer process will send a message with necessary order information (receiver's name, E-retailer's order number, shipping address, shipping requirement, etc.) for E-distributor to fulfill the order. Please notice that E-distributor does not need customer's credit card number and other buyer's information, although it is helpful for E-distributor to provide additional services that if E-retailer is willing to pass additional information to E-distributor. The E-retailer controls the crucial customer information.

11) Upon receiving the customer order request from E-retailer, E-distributor will validate the order by the following processes or similar processes for different product types and situations with the same core concept.

Allocate and lock the merchandise so that different E-retailers or session may not sell the same item.

If the ordered item that was previously available is still available, lock the item and proceed the process.

If the ordered item that was previously available is locked by the other E-retailer while confirmed order was received, an conditional order confirmation message will send back to E-retailer to pass on to the online customer. E-distributor or E-retailer may provide a special discount in order to keep the customer for the not-in-stock item and will-be-delay shipment.

If the online customer refuse to continue shopping, the process ends.

If the online customer accepts the not-currently-available order, the process will proceed.

Check the E-retailer's account balance

The amount to be deducted from E-retailer's E-deposit account equals to the sum of the total order whole price, the fulfillment charge if the order is approved and any E-fee associating with this transaction.

If the E-deposit residue in E-retailer's account is running low, the E-retailer may be in risk to have insufficient fund in the E-deposit account for continuous operation. A warning note of possible insufficient fund will be send to E-retailer via email, fax and/or any other acceptable means between E-distributor and E-retailer so that the E-retailer can take actions to refill E-deposit or apply for additional E-credit.

If the E-deposit residue in E-retailer's account and any E-credit can cover the transaction, the order will be confirmed by E-distributor to E-retailer.

If the E-deposit balance and E-credit can not cover the transaction, the process may continue to check if the E-retailer qualify for additional E-credit to complete the order.

If the E-credit is approved and has enough to cover the transaction, the order will be confirmed by E-distributor to E-retailer.

If the additional E-credit still can not cover the transaction, an order rejection notification will be sent to E-retailer.

Upon receiving the order rejection notification from E-distributor, the E-retailer side process will go into pre-defined exception handling procedure. The pre-defined exception handling procedure is defined by E-retailer and within the limitation of agreement between E-distributor and E-retailer. In another word, E-retailer has control over exception handling.

Upon receiving the order confirmation from E-distributor, the E-retailer will then confirm the order to customer and proceed the online shopping process.

Side note: since the above information communication is conducted in electronic form in the distributed computer system, the above additional checking processes is not noticeable by end customer.

12) E-distributor fulfills the order.

E-distributor packages the merchandise

E-distributor ships the merchandise via customer specified shipping method.

Once both the Consumer and E-distributor confirm the order, the E-retailer will be able to complete the order and deposit the order to bank and recognize the revenue fairly shortly, if not immediately. E-distributor can also recognize the revenue immediately by deducting proper amount from E-retailer's E-deposit account.

Upon the order from E-retailer is fulfilled by shipping the merchandise out of the door, The E-distributor will notify E-retailer and Consumer (if E-retailer choose to let E-distributor to do so) the order being fulfill with product shipping tracking information.

Please note that the above scenario processes are to demonstrate the core concept of the present invention. The real life implementation will have more specific steps depending on different products and markets.

In the above process description, the communication between customer and E-retailer is through the E-retailer order process, typically by customer browsing E-retailer's Web pages, online form filling and message transmission. E-retailer can customize its order process and is responsible for maintaining its Web pages. The E-distributor may also provide a set of sample order process for E-retailer to use or modify. The communication between E-distributor and E-retailer is automatically through any suitable pre-defined secure and accurate message passing protocol in the distributed computer system. All the existing and future secure online message passing protocols and programming languages can be used to implement the processes.

Although the preferred embodiments described above uses online shopping and distributed computer message passing for order information communication, the present invention can also be used in any traditional retailing and shipping style. For instance, a door-to-door sales person who established an account at E-distributor can create his/her own product catalog to sell merchandise in his/her selected communities. After customer order has been confirmed, the door-to-door sale person can use any mean of communication (Internet, phone, fax or even in person) to pass on needed order fulfillment information to E-distributor to complete the order process. A few days later, the ordered merchandise will be shipped to customer directly. Or an existing mom-and-pop shop can create an in-store product catalog from E-distributor's database and establish an account with E-distributor.

The key points of the invention are the followings:

E-distributor fulfills the order, not E-retailer

E-distributor bears the cost of the inventory infrastructure, not E-retailer

E-distributor selects quality manufacturers and stocks inventory to create flexible and valuable product offering, E-retailer only needs to select what to sell from E-distributor's product offerings.

E-retailer has freedom to decide the retail price and marketing strategies to the customers, communicates directly with customers.

The E-deposit governs the transaction and relationship of the E-distributor and E-retailer.

In essence, the redefined distributor in the present invention, E-distributor, conducts all activities that were conducted by the distributor of the traditional value chain. The only difference is that, instead of shipping merchandise to retailer in small volume for sales by retailer, the E-distributor ships merchandise directly to end customer in exact unit purchased by E-retailer's customer. E-distributor does not need to spend a great deal of resources on general public marketing activities like E-retailer and current online retailers do. From E-retailer side, since the burden of inventory is removed, E-retailers can concentrate on providing better contents and better services, and establishing stronger brand image. In order to support the activities change, the invention presents the concept of E-deposit to govern the relationship between E-distributor and E-retailer and the needed processes to be implemented in E-retailer server computer and E-distributor server computer.

The present invention reduces one shipment activity in the traditional value chain and save the cost of inventory from E-retailer side. Therefore, the overall total cost of the updated value chain in the present invention will be less than the overall cost of the traditional value chain and current online retailer value chain. The profit margin allocation will be redistributed among manufacturer, E-distributor, E-retailer and customer. Since the total cost is reduced, all parties involved will eventually benefit from the change.

As the E-distributor getting more established, some special arrangements could be set up between manufacturer and E-distributor so that the order fulfillment portion can be done by manufacturer directly to further reduce the cost. If this situation happens, the hierarchical ordering, billing and distribution processes will extend to manufacturer as well. This alternative application of the invention is illustrated in FIG. 4.

Please notice that the invention does not limit to only one E-distributor. Multiple E-distributors can exist to server multiple E-retailers. The relationship between E-distributors and E-retailers can be one-to-one, one-to-many, many-to-many and many-to-one. The present invention reveals the hierarchical real time product ordering, billing and distribution processes can work on all above E-distributor and E-retailer mapping relationships.

The present invention confirms the value of the distributor and the importance of all the roles in traditional value chain even in the Internet Age. The part that needs to be improved and redefined is the activities that each role performs in the value chain, not that certain role needs to be eliminated as current online retailer suggested. In fact, the hierarchy of the traditional value chain has to be maintained so that each role can specialize and handle reasonable size of customer pools and merchandise volumes and product varieties.

What I claim as my invention is:

1. A method for online ordering and billing among E-distributor, E-retailer and customer comprising a distributed computer system connected by communication links to at least one said E-distributor server computer that executes the said customer orders transmitted from said E-retailers, a group of said E-retailer server computers that execute the said customer orders, a group of said customers connected to client computers to browse said E-retailer stores and submit order to said E-retailer servers, said method comprising of:
Said E-distributor implementing the said E-deposit account method for establishing relationship with said E-retailer
At least one of the said E-distributor's servers providing said E-retailers with product information, pricing rules, billing rules and executing said customer orders.
At least one of the said E-retailer's server computer providing product information, retail price, promotion information to said customers and executing said customer orders.
At least one said client computer that said customer logging on to conduct online shopping activities through the said E-retailer's server.

2. The method of claim 1, said at least one of said E-distributor's server step further comprising the steps of
Said E-distributor creating wholesale product database.
Said E-distributor creating acceptable retail pricing rules for said E-retailer to further specify product retail prices.
Said E-distributor creating billing rules by establishing product wholesale prices, E-fee charging criterions, E-credit issuing guidelines and fulfillment charge schedule.
Said E-distributor establishing said fulfillment charge schedule, wherein said fulfillment charge schedule includes shipping, handling, material, overhead and appropriate tax.
Said E-distributor receiving the said customer order information from the said E-retailer's server.
Said E-distributor, upon said order confirmation, releasing the said products and charging said E-retailer's said E-deposit account for the sum of said total wholesale price, any said E-fee associating with this transaction and said fulfillment charge defined by said E-distributor.
Said E-distributor fulfilling the said customer order by shipping the said products to the said customer.
Said E-distributor securing the said product availability via inventory or other acceptable means.

3. The step of claim 2, wherein said E-distributor receiving the said customer order information step further comprising the steps of:
Said E-distributor checking the said product availability.
Said E-distributor locking said product if it is available.
Said E-distributor notifying said E-retailer with a message through said communication links if said product is not available.
Said E-distributor notifying said E-retailer with a message through said communication links if said E-retailer's status is SUSPENDED.

4. The method of claim 1, said at least one of the said E-retailer's server step further comprising the steps of
Said E-retailer accessing the said E-distributor product information via network or printed said E-distributor's published product information
Said E-retailer deciding what to sell by selecting the said E-distributor's product offerings.
Said E-retailer deciding how to sell by creating its own marketing methods.
Said E-retailer accessing the wholesale price information from said E-distributor through network or printed price book.
Said E-retailer deciding the retail price via various pricing rules that are accepted by the said E-distributor on single product, group of products or the entire products.
Said E-retailer creating the store appearance based on the selected product offerings and pricing.
Said E-retailer receiving the said customer's order by said customer conducting shopping activities at said E-retailer's online store.
Said E-retailer processing the said customer's order by sending necessary order information to said E-distributor for said order fulfillment purpose.
Said E-retailer, upon said E-distributor locking and releasing the said products, charging the total said E-retailer-defined retail price and the said E-retailer-defined shipping and handling charges to the said customer's credit card or any acceptable means of payment methods approved by said E-retailer.
Said E-retailer conducting said E-retailer-defined exception handling routine to handle said customer order if said E-retailer receiving said product unavailable message or said E-retailer SUSPENDED status message from said E-distributor.

5. The method of claim 1, said at least one of the said client computer step further comprising the steps of
Said customer browsing the said E-retailer's online store and going through any acceptable online shopping processes that are designed or adopted by said E-retailer.
Said customer selecting the products and confirming the order, and said order is processed on said E-retailer's server.

6. The method of claim 1, further comprising the steps of said E-retailer deciding said product retail price and concerning said product availability:
Using the pricing rule on the said product to decide the retail price if said pricing rule exists for said product.
Using the said E-distributor suggested retail price for the said product if no pricing rule exists for said product.
Assuming said product is available if not receiving said product unavailable message from said E-distributor.

7. A method of establishing E-deposit account for governing the transaction and relationship among E-distributor, E-retailer and customers, said method comprising the steps of:
Said E-retailer opening an said E-deposit account with said E-distributor by depositing an E-deposit in the account, wherein the said E-deposit can be certain amount of money or line of credit approved by other financial institute or the combination of said money and said line of credit.
Said E-retailer maintaining a minimum E-deposit balance to continue its retail activities with said E-distributor, wherein the said minimum E-deposit balance being specified upon opening the account with said E-distributor and can be reviewed and adjusted by said E-distributor upon said E-retailer's request or as needed.
Said E-retailer's E-deposit account will be charged by said E-distributor to said E-distributor's account upon said customer completing said order process for the transaction amount equal to the sum of said product wholesale price, any E-fee associating with the transaction and said fulfillment charges defined by said E-distributor.
Said E-retailer can be given E-credit in its said E-deposit account by said E-distributor after certain criterions being met, wherein said E-credit enables said E-retailer to sell more than the current balance of its said E-deposit allows, wherein said certain criterions can be any guidelines agreed by said E-distributor.
Said E-distributor may choose to charge a reasonable E-fee to some or all said E-retailers based on certain criterions, wherein said E-fee enables E-distributor to govern and encourage said E-retailers conducting proper fair competition behaviors or any other purposes that said E-distributor deems proper, wherein said certain criterions can be any guidelines agreed by both said E-distributor and said E-retailer.
Said E-distributor confirming said order to said E-retailer by sending a message through said communication links if the sum of the remaining balance of said E-deposit and any said E-credit is higher than said transaction amount.

8. The method of claim 7, further comprising the steps of:
Said E-retailer should have an initial E-deposit balance higher than said minimum E-deposit balance requirement in order to conduct business and making transactions.
Said E-retailer is responsible to maintain the said minimum E-deposit balance in its said E-deposit account.
Said E-retailer is responsible to refill the said E-deposit account and maintain a reasonable E-deposit level above the said minimum E-deposit balance requirement according to its normal transaction volume to prevent account suspension due to insufficient fund in the said E-deposit account.
Said E-retailer specifying a balance level that will trigger a warning message notifying said E-retailer via network, telephone, fax or any other feasible means that its said minimum E-deposit balance is approaching or has met.

9. The method of claim 7, further comprising the steps of said E-distributor checking the status, processing the balance and adjust the status of the said E-retailer's said E-deposit account:
Changing said E-retailer's status from ACTIVE to SUSPENDED if the said E-retailer's E-deposit account balance is less than said minimum E-deposit account balance requirement.
Checking to see if the sum of said product wholesale price, any E-fee associating with the transaction and said fulfillment charges defined by said E-distributor will decrease the sum of the current said E-deposit account balance and any said E-credit to be less than zero.
If so, the said E-retailer's status will be changed from ACTIVE to SUSPENDED, and the E-retailer's current transactions will be suspended.
Changing said E-retailer's status from SUSPENDED to ACTIVE upon said E-retailer refill said E-deposit account above said minimum E-deposit balance.

10. The method of claim 7, wherein one or more steps of said E-deposit method can be used to establish said E-distributor and product manufacturer relationship so that the said product manufacturer can ship the said products to said customer directly to achieve further cost reduction of value chain activities.
